(19) United States
(12) Patent Application Publication
(10) Pub. No.: US 2017/0292850 A1
(43) Pub. Date: Oct. 12, 2017

(54) Method of Selecting Vehicles and Off-road Trails and Related System

(71) Applicant: MITAC INTERNATIONAL CORP., Taoyuan City (TW)

(72) Inventor: Naveen Madapati, Santa Clara, CA (US)

(21) Appl. No.: 15/096,290

(22) Filed: Apr. 12, 2016

(51) Int. Cl. G01C 21/36; G01S 19/42

(52) U.S. Cl. CPC G01C 21/36; G01S 19/42

(57) ABSTRACT

A method of selecting vehicles and off-road trails includes receiving a request to travel on an off-road trail, receiving specifications of at least one available vehicle that can be used for traveling off-road, determining whether any off-road trails can be traveled on with the at least one available vehicle, receiving selection of an off-road trail and a vehicle, wherein the selected vehicle is qualified to travel on the selected off-road trail, and generating navigation assistance instructions to guide a user to drive the selected vehicle to a starting point of the selected off-road trail and to guide the user to drive on the selected off-road trail.

### BACKGROUND OF THE INVENTION

### 1. Field of the Invention

The invention relates to a navigation system, and more particularly, to a system for selecting and navigating on off-road trails.

### 2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Portable GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken. The navigation devices can either be personal navigation devices such as GPS devices or mobile phones that contain the functionality of GPS receivers and navigation software.

When a driver decides to drive a vehicle on an off-road trail, it is necessary to first consider whether the vehicle is capable of handling the challenges associated with the off-road trail. Each vehicle manufacturer has its own strengths and weaknesses in terms of features supported in the various vehicle models sold by that manufacturer. Similarly, each off-road trail has its own characteristics that will determine whether a given vehicle is suitable for driving on that off-road trail or not. For instance, some off-road trails have sharp turns, may be located at high elevations, and so on. When a user is going on a selected off-road trail, choosing the right vehicle for the selected off-road trail is very important due to the extreme and strenuous conditions associated with off-road trails.

However, most drivers do not know the technical specifications of the vehicles that they drive, and whether their vehicles are suitable for off-road trails that they wish to drive on. Therefore, there exists a need for a way to inform users about which vehicles are suitable for which off-road trails.

### SUMMARY OF THE INVENTION

It is therefore one of the primary objectives of the claimed invention to provide a method of selecting vehicles and off-road trails in order to find vehicles that can be used on off-road trails.

According to an exemplary embodiment of the claimed invention, a method of selecting vehicles and off-road trails is disclosed. The method includes receiving a request to travel on an off-road trail, receiving specifications of at least one available vehicle that can be used for traveling off-road, determining whether any off-road trails can be traveled on with the at least one available vehicle, receiving selection of an off-road trail and a vehicle, wherein the selected vehicle is qualified to travel on the selected off-road trail, and generating navigation assistance instructions to guide a user to drive the selected vehicle to a starting point of the selected off-road trail and to guide the user to drive on the selected off-road trail.

According to another exemplary embodiment of the claimed invention, a system for selecting vehicles and off-road trails is disclosed. The system includes a server, comprising a map and trail database comprising map data, address data, and off-road trail data, application software receiving a request to travel on an off-road trail, receiving specifications of at least one available vehicle that can be used for traveling off-road, consulting the map and trail database to determine whether any off-road trails can be traveled on with the at least one available vehicle, receiving selection of an off-road trail and a vehicle, and generating navigation assistance instructions to guide a user to drive the selected vehicle to a starting point of the selected off-road trail and to guide the user to drive on the selected off-road trail, wherein the selected vehicle is qualified to travel on the selected off-road trail, and a processor for executing the application software and controlling operation of the server. The system also includes a navigation device, comprising a memory storing the navigation assistance instructions generated by the server, a global positioning system (GPS) receiver detecting the current position of the navigation device, routing software guiding the user to follow the navigational assistance instructions stored in the memory, and a processor executing the routing software and controlling operation of the navigation device.

It is an advantage that the present invention helps the user to determine which vehicles are suitable for driving on which off-road trails. This helps to ensure that the selected vehicle the user drives does not become stuck or damaged while the user drives on the selected off-road trail. For users that already have access to a particular vehicle, the present invention helps the user to find off-road trails that the particular vehicle can handle. For users that wish to drive on a particular off-road trail, the present invention helps to determine which vehicles are qualified to travel on the particular off-road trail. Then, navigation assistance instructions are generated in order to guide the user to drive the selected vehicle to a starting point of the selected off-road trail and to guide the user to drive on the selected off-road trail.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a system for selecting vehicles and off-road trails according to the present invention.

FIG. 2 is a functional block diagram of a navigation device according to the present invention.

FIG. 3 is a flowchart illustrating an overview of the method of selecting vehicles and off-road trails and receiving navigation assistance according to the present invention.

FIG. 4 is a flowchart illustrating the method of searching for off-road trails when the user already has a vehicle that is listed in the vehicle database, and receiving navigation assistance according to the present invention.

FIG. 5 is a flowchart illustrating the method of searching the vehicle database for a qualified vehicle to go on an off-road trail that the user selects from the map and trail database, and receiving navigation assistance according to the present invention.

### DETAILED DESCRIPTION

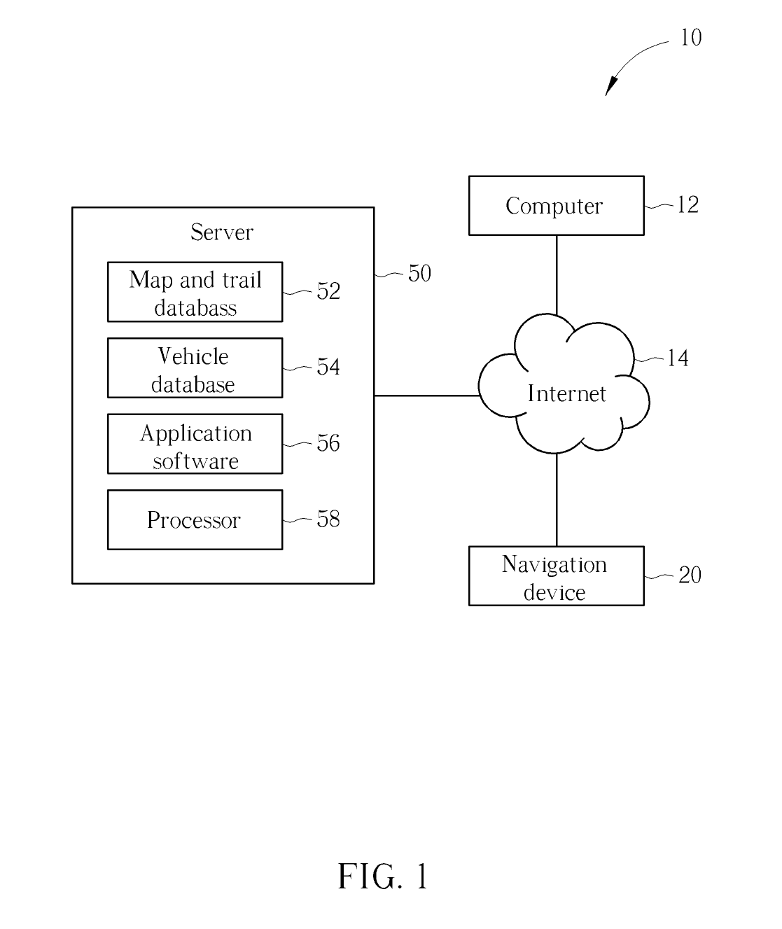

Please refer to FIG. 1. FIG. 1 is a block diagram of a system 10 for selecting vehicles and off-road trails according to the present invention. The system 10 helps users to match selected vehicles with suitable off-road trails and to match selected off-road trails with suitable vehicles. The system 10 comprises a server 50, a computer 12, and a navigation device 20 that may communicate with each other through the internet 14. The server 50 contains a map and trail database 52 comprising map data, address data, and off-road trail data including characteristics of a plurality of off-road trails. The server 50 also contains a vehicle database 54 containing details about a plurality of vehicles, including technical specifications of the plurality of vehicles in the vehicle database 54. The server 50 further contains application software 56 that is able to access both the map and trail database 52 and the vehicle database 54 for helping to match off-road trails with vehicles. The server 50 includes a processor 58 for executing the application software 56 and for controlling operation of the server 50.

There are many possible technical specifications that can be described for each of the plurality of vehicles included in the vehicle database 54. Some examples of the technical specifications are shown as follows for a hypothetical sports utility vehicle (SUV). The vehicle database 54 can specify the following features of the SUV: steering (e.g. rack and pinion, electric assistance) traction control (yes or no), stability control (yes or no), all-wheel drive (yes or no), seatbelts (how many are included in the vehicle), airbags (how many are included in the vehicle), front suspension (e.g. independent, Macpherson strut), rear suspension (e.g. independent, multi-link), front brakes (e.g. disc, anti-lock braking system), rear brakes (e.g. disc, anti-lock braking system), time needed to accelerate from 0 to 100 km/h (e.g. 7.6 s), time needed to accelerate from 80 to 120 km/h (e.g. 5.7 s), top speed (e.g. 198 km/h), and braking distance when traveling at a specified speed (e.g. 46.2 m).

Similarly, there are many possible characteristics of off-road trails that can be included in the map and trail database 52. Examples of these characteristics include measurements related to how rough the road is, how high the elevation is, how steep the slopes are, how sharp the turns are, and how deep the mud is on the off-road trails. The map and trail database 52 may contain data on off-road trails all over the world, and can be expanded as more contributions are received regarding new off-road trails.

The server accesses the map and trail database 52 and the vehicle database 54 using the application software 56 for determining which off-road trails are suitable for which vehicles. This determination is made by comparing the characteristics of off-road trails in the map and trail database 52 to specifications of the plurality of vehicles in the vehicle database 54. Once a match is made, and an off-road trail is selected, the application software 56 generates navigation assistance instructions in order to guide the user to drive the selected vehicle to a starting point of the selected off-road trail and to guide the user to drive on the selected off-road trail. The generated navigation assistance instructions can then be sent from the server 50 to the navigation device 20 via the internet 14 in order to provide guidance to the user of the navigation device 20.

In FIG. 1, the computer 12 may be used for interacting with the server 50 in order to input user preferences or selections regarding vehicles and off-road trails. The computer 12 may be a desktop computer, a notebook computer, a tablet computer, a mobile phone, or other computing devices. Instead of the computer 12, the user may interact with the server 50 using the navigation device 20. The navigation device 20 may be a personal navigation device, also called a “GPS device”, or a mobile phone.

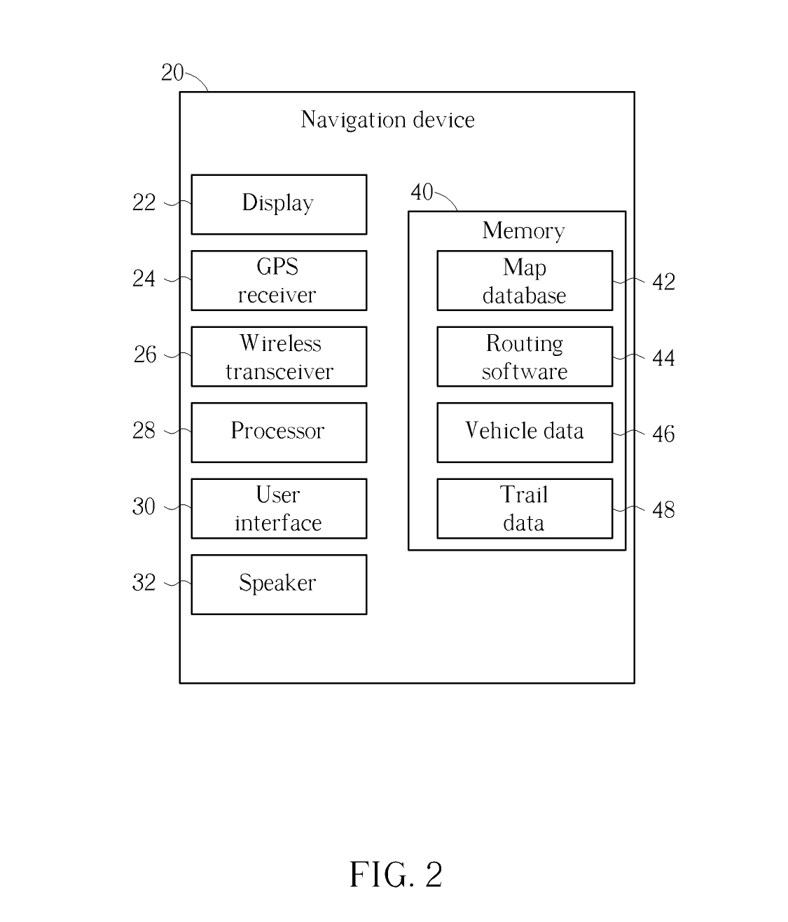

Please refer to FIG. 2. FIG. 2 is a functional block diagram of the navigation device 20 according to the present invention. The navigation device 20 contains a display 22 which can be a touch sensitive display, a GPS receiver 24 for receiving the current coordinates of the navigation device 20, and a wireless transceiver 26 such as a Wireless Fidelity (Wi-Fi) transceiver or Bluetooth transceiver, or a mobile internet transceiver such as a third generation of mobile telecommunications technology (3G) transceiver or a fourth generation of mobile telecommunications technology (4G) transceiver for allowing the navigation device 20 to communicate with the server 50 via the internet 14. The navigation device 20 also comprises a processor 28 for controlling operation of the navigation device 20 and executing code for operating the navigation device 20, a user interface 30, a speaker 32, and memory 40. The memory 40 may be non-volatile memory such as flash memory, and is used to store a map database 42 containing map data and points of interest. The memory 40 also stores routing software 44, any vehicle data 46 related to the user's vehicle selections that the user wishes to store, and trail data 48 containing information about off-road trails stored in the memory 40. The vehicle data 46 may store which vehicles the user owns or has access to, or even vehicles that the user is interested in driving. The trail data 48 may store information about the off-road trails that the user has been on in the past, about the user's favorite off-road trails, or about off-road trails that the user wishes to travel on. The routing software 44 is executed by the processor 28, and provides navigational guidance to destinations. The routing software 44 can receive via the internet 14 the navigation assistance instructions generated by the server 50, and can guide the user to follow the received navigation assistance instructions. Otherwise, the navigation device 20 can receive information related to the selected off-road trail and store this route information in the trail data 48 section of the memory 40 for use by the routing software 44 in guiding the user to drive both to the selected off-road trail and on the selected off-road trail.

An important part of the present invention is determining which off-road trails are suitable for which vehicles. The application software 56 determines this by comparing the characteristics of off-road trails in the map and trail database 52 to specifications of the plurality of vehicles in the vehicle database 54. When the technical specifications of a vehicle are suitable for the characteristic of an off-road trail, a match is noted. A particular vehicle may be matched to a single off-road trail or multiple off-road trails, or no match may be found at all. Similarly, a particular off-road trail may be matched to a single vehicle or multiple vehicles, or no match may be found at all. If no vehicle in the vehicle database 54 matches a selected off-road trail that the user has chosen, then the application software 56 can suggest the technical specifications that the user should look for in a vehicle if the user still wishes to drive on the selected off-road trail.

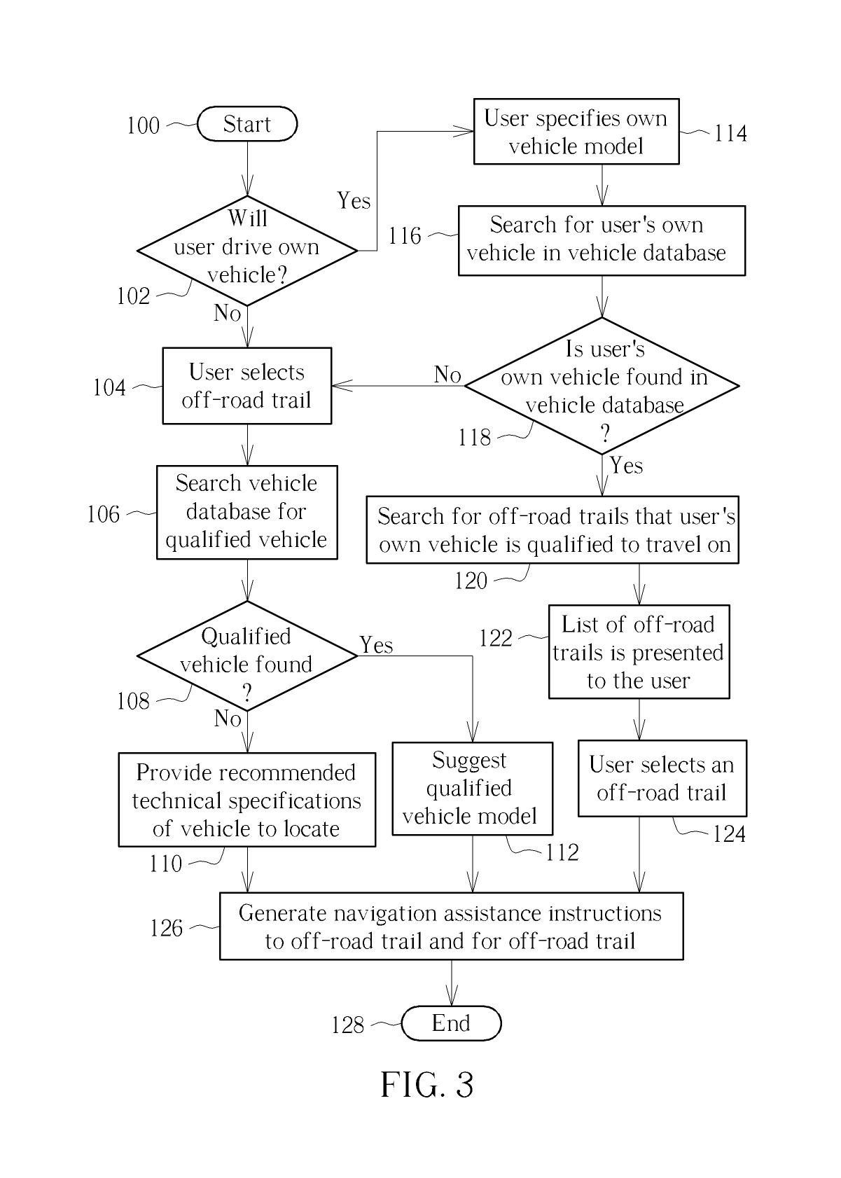

Please refer to FIG. 3. FIG. 3 is a flowchart illustrating an overview of the method of selecting vehicles and off-road trails and receiving navigation assistance according to the present invention. Steps contained in the flowchart will be explained below.

Step 100: Start. At this time, the user decides to go on an off-road trail and requests assistance with selecting a vehicle and an off-road trail. Alternatively, the request for assistance may automatically be generated by a predefined algorithm executed in software instead of requiring a user to trigger the request.

Step 102: Determine if the user will drive the user's own vehicle. If so, go to step 114. If not, go to step 104.

Step 104: Since the user does not have a vehicle selected, the user may select an off-road trail that the user wishes to drive on. This off-road trail is preferably selected from a plurality of trails listed in the map and trail database 52.

Step 106: The application software 56 searches for vehicles in the vehicle database 54 that are qualified to travel on the selected off-road trail.

Step 108: Determine if at least one vehicle is found that is qualified to travel on the selected off-road trail. If so, go to step 112. If not, go to step 110.

Step 110: Since no vehicle was found in the vehicle database 54 that is qualified to travel on the selected off-road trail, the application software 56 suggests the technical specifications that the user should look for in a vehicle if the user still wishes to drive on the selected off-road trail. The user can then go rent a vehicle having these technical specifications. Proceed to step 126.

Step 112: Suggest a vehicle model that is qualified to travel on the selected off-road trail. If more than one vehicle from the vehicle database 54 is qualified, then all of the qualified vehicles can be listed, or a particular qualified vehicle can be recommended. Proceed to step 126.

Step 114: The user specifies the model of the user's own vehicle that the user wishes to drive.

Step 116: The application software 56 searches in the vehicle database 54 for the user's own vehicle.

Step 118: Determine if the user's own vehicle is found in the vehicle database 54. If so, go to step 120. If not, go to step 104 to select an off-road trail.

Step 120: The application software 56 searches the map and trail database 52 for off-road trails that the user's own vehicle is qualified to travel on.

Step 122: A list of off-road trails that the user's own vehicle is qualified to travel on is presented to the user.

Step 124: The user selects an off-road trail from the list of off-road trails that the user's own vehicle is qualified to travel on.

Step 126: The application software 56 generates navigation assistance instructions in order to guide the user to drive the selected vehicle to a starting point of the selected off-road trail and to guide the user to drive on the selected off-road trail.

Step 128: End.

In the present invention, the user either already has or does not have a vehicle that is listed in the vehicle database 54. If the user has a vehicle that is listed in the vehicle database 54, then the user will be interested in finding an off-road trail to take the vehicle on. If the user does not have a vehicle that is listed in the vehicle database 54, then the user can first select an off-road trail that the user is interested in, and then can see which vehicles in the vehicle database 54 are qualified to drive on the selected off-road trail. Once the user sees which vehicles qualify, the user can try to go out and rent a qualified vehicle.

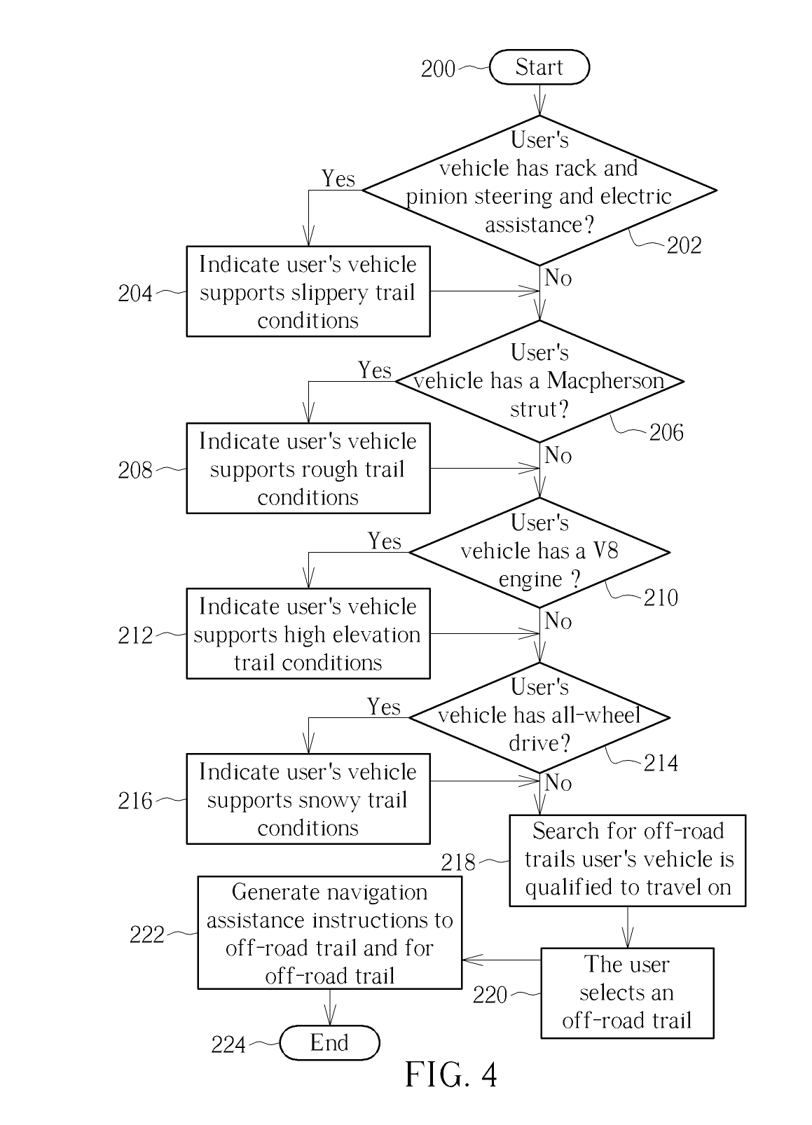

Please refer to FIG. 4. FIG. 4 is a flowchart illustrating the method of searching for off-road trails when the user already has a vehicle that is listed in the vehicle database 54, and receiving navigation assistance according to the present invention. Steps contained in the flowchart will be explained below.

Step 200: Start. The user already has a vehicle that is listed in the vehicle database 54, and the user is interested in taking the user's vehicle on an off-road trail. Alternatively, a request for assistance may automatically be generated by a predefined algorithm executed in software instead of requiring a user to trigger the request.

Step 202: Determine if the steering specification of the user's vehicle indicates that the user's vehicle has rack and pinion steering and electric assistance. If so, go to step 204. If not, go to step 206.

Step 204: The application software 56 marks a flag indicating that the user's vehicle supports slippery trail conditions.

Step 206: Determine if the front suspension specification of the user's vehicle indicates that the user's vehicle has a Macpherson strut. If so, go to step 208. If not, go to step 210.

Step 208: The application software 56 marks a flag indicating that the user's vehicle supports rough trail conditions.

Step 210: Determine if the user's vehicle has a V8 engine. If so, go to step 212. If not, go to step 214.

Step 212: The application software 56 marks a flag indicating that the user's vehicle supports high elevation trail conditions.

Step 214: Determine if the user's vehicle indicates has all-wheel drive. If so, go to step 216. If not, go to step 218.

Step 216: The application software 56 marks a flag indicating that the user's vehicle supports snowy trail conditions.

Step 218: The application software 56 analyzes all of the trail conditions that the user's vehicle supports, and searches the map and trail database 52 for off-road trails that the user's vehicle is qualified to travel on. A list of candidate off-road trails is presented to the user.

Step 220: The user selects an off-road trail from the list of candidate off-road trails.

Step 222: The application software 56 generates navigation assistance instructions in order to guide the user to drive the user's vehicle to a starting point of the selected off-road trail and to guide the user to drive on the selected off-road trail.

Step 224: End.

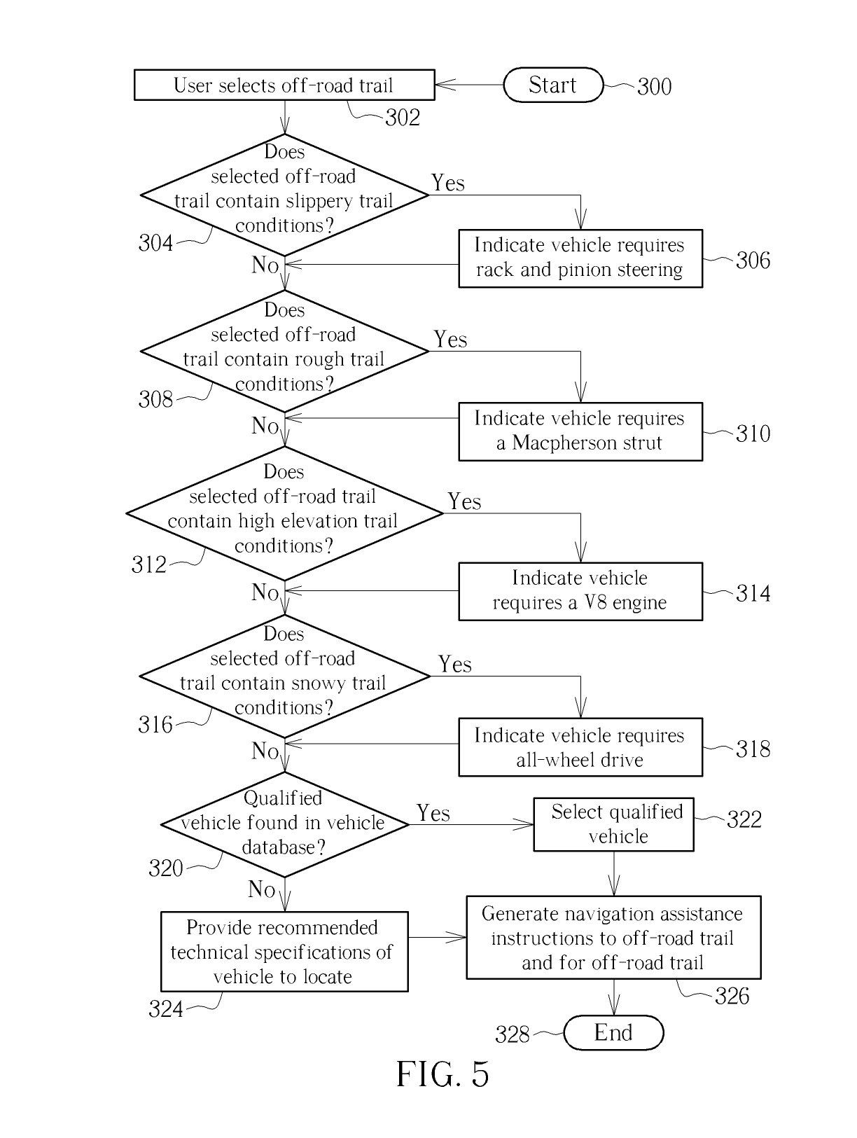

Please refer to FIG. 5. FIG. 5 is a flowchart illustrating the method of searching the vehicle database 54 for a qualified vehicle to go on an off-road trail that the user selects from the map and trail database 52, and receiving navigation assistance according to the present invention. Steps contained in the flowchart will be explained below.

Step 300: Start. The user has not already decided on a vehicle to use for going on an off-road trail.

Step 302: The user selects an off-road trail that the user is interested in driving on from the map and trail database 52.

Step 304: Determine if the selected off-road trail contains slippery trail conditions. If so, go to step 306. If not, go to step 308.

Step 306: The application software 56 marks a flag indicating that rack and pinion steering and electric assistance is required to be supported in the technical specifications of a selected vehicle.

Step 308: Determine if the selected off-road trail contains rough trail conditions. If so, go to step 310. If not, go to step 310.

Step 310: The application software 56 marks a flag indicating that a Macpherson strut is required to be supported in the technical specifications of a selected vehicle.

Step 312: Determine if the selected off-road trail contains high elevation trail conditions. If so, go to step 314. If not, go to step 316.

Step 314: The application software 56 marks a flag indicating that a V8 engine is required to be supported in the technical specifications of a selected vehicle.

Step 316: Determine if the selected off-road trail contains snowy trail conditions. If so, go to step 318. If not, go to step 320.

Step 318: The application software 56 marks a flag indicating that all-wheel drive is required to be supported in the technical specifications of a selected vehicle.

Step 320: Determine if the vehicle database 54 contains a qualified vehicle to go on the selected off-road trail. To accomplish this, the application software 56 analyzes all of the required technical specifications and searches the vehicle database 54 for any candidate vehicles having these required technical specifications. If a qualified candidate vehicle is found, go to step 322. If not, go to step 324.

Step 322: A list of qualified candidate vehicles is presented to the user for the user to make a selection. Alternatively, one recommended vehicle out of the list of qualified candidate vehicles can be presented to the user. Proceed to step 326.

Step 324: Since no vehicles in the vehicle database 54 qualify to go on the selected off-road trail, the application software 56 suggests the technical specifications that the user should look for in a vehicle if the user still wishes to drive on the selected off-road trail. The user can then go rent a vehicle having these technical specifications, and this rented vehicle becomes the selected vehicle.

Step 326: The application software 56 generates navigation assistance instructions in order to guide the user to drive the selected vehicle to a starting point of the selected off-road trail and to guide the user to drive on the selected off-road trail.

Step 328: End.

Please note that the off-road trail characteristics and vehicle technical specifications described in the flowcharts of FIG. 4 and FIG. 5 are merely used as examples, and other criteria could be used instead of, or in addition to, the criteria shown in these flowcharts.

In summary, the present invention helps a user to determine which vehicles are suitable for driving on which off-road trails. This helps to ensure that the selected vehicle is qualified for a selected off-road trail and that the selected vehicle does not become stuck or damaged while the user drives on the selected off-road trail. For users that already have access to a particular vehicle, the present invention helps the user to find off-road trails that the particular vehicle can handle. For users that wish to drive on a particular off-road trail, the present invention helps to determine which vehicles are qualified to travel on the particular off-road trail. Then, navigation assistance instructions are generated in order to guide the user to drive the selected vehicle to a starting point of the selected off-road trail and to guide the user to drive on the selected off-road trail.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of selecting vehicles and off-road trails, the method comprising:
receiving a request to travel on an off-road trail;
receiving specifications of at least one available vehicle that can be used for traveling off-road;
determining whether any off-road trails can be traveled on with the at least one available vehicle;
receiving selection of an off-road trail and a vehicle, wherein the selected vehicle is qualified to travel on the selected off-road trail; and
generating navigation assistance instructions to guide a user to drive the selected vehicle to a starting point of the selected off-road trail and to guide the user to drive on the selected off-road trail.

2. The method of claim 1, further comprising:
receiving, from the user, an indication of the selected vehicle;
searching a trail database containing details about a plurality of off-road trails to locate at least one candidate off-road trail that the selected vehicle is qualified to travel on, wherein searching the trail database comprises comparing specifications of the selected vehicle to characteristics of the plurality of off-road trails in the trail database; and
receiving, from the user, an indication of the selected off-road trail that is selected from the at least one candidate off-road trail.

3. The method of claim 1, further comprising:
receiving, from the user, an indication of the selected off-road trail;
searching a vehicle database containing details about a plurality of vehicles to locate at least one candidate vehicle that is qualified to be driven on the selected off-road trail, wherein searching the vehicle database comprises comparing characteristics of the selected off-road trail to specifications of the plurality of vehicles in the vehicle database; and
receiving, from the user, an indication of the selected vehicle that is selected from the at least one candidate vehicle.

4. The method of claim 1, further comprising:
receiving, from the user, an indication of the selected off-road trail;
searching a vehicle database containing details about a plurality of vehicles to search for a candidate vehicle that is qualified to be driven on the selected off-road trail, wherein searching the vehicle database comprises comparing characteristics of the selected off-road trail to specifications of the plurality of vehicles in the vehicle database;
determining that no candidate vehicle is qualified to be driven on the selected off-road trail;
providing minimum recommended specifications for a vehicle that is qualified to be driven on the selected off-road trail; and
the user selecting a vehicle based on the provided minimum recommended specifications.

5. A system for selecting vehicles and off-road trails, the system comprising:
a server, comprising:
a map and trail database comprising map data, address data, and off-road trail data;
application software receiving a request to travel on an off-road trail, receiving specifications of at least one available vehicle that can be used for traveling off-road, consulting the map and trail database to determine whether any off-road trails can be traveled on with the at least one available vehicle, receiving selection of an off-road trail and a vehicle, and generating navigation assistance instructions to guide a user to drive the selected vehicle to a starting point of the selected off-road trail and to guide the user to drive on the selected off-road trail, wherein the selected vehicle is qualified to travel on the selected off-road trail; and
a processor for executing the application software and controlling operation of the server; and
a navigation device, comprising:
a memory storing the navigation assistance instructions generated by the server;
a global positioning system (GPS) receiver detecting the current position of the navigation device;
routing software guiding the user to follow the navigational assistance instructions stored in the memory; and
a processor executing the routing software and controlling operation of the navigation device.

6. The system of claim 5, wherein the application software receives, from the user, an indication of the selected vehicle, searches the map and trail database containing details about a plurality of off-road trails to locate at least one candidate off-road trail that the selected vehicle is qualified to travel on, and receives, from the user, an indication of the selected off-road trail that is selected from the at least one candidate off-road trail, wherein the application software searches the map and trail database by comparing specifications of the selected vehicle to characteristics of the plurality of off-road trails in the map and trail database.

7. The system of claim 5, wherein the server further comprises a vehicle database containing details about a plurality of vehicles and their corresponding specifications, and the application software receives, from the user, an indication of the selected off-road trail, searches the vehicle database to locate at least one candidate vehicle that is qualified to be driven on the selected off-road trail by comparing characteristics of the selected off-road trail to specifications of the plurality of vehicles in the vehicle database, and receives, from the user, an indication of the selected vehicle that is selected from the at least one candidate vehicle.

8. The system of claim 5, wherein the server further comprises a vehicle database containing details about a plurality of vehicles and their corresponding specifications, and the application software receives, from the user, an indication of the selected off-road trail, searches the vehicle database to locate a candidate vehicle that is qualified to be driven on the selected off-road trail by comparing characteristics of the selected off-road trail to specifications of the plurality of vehicles in the vehicle database, determines that no candidate vehicle is qualified to be driven on the selected off-road trail, and provides minimum recommended specifications for a vehicle that is qualified to be driven on the selected off-road trail, wherein the user selects a vehicle based on the provided minimum recommended specifications.
